(19) United States
(12) Patent Application Publication
(10) Pub. No.: US 2019/0387311 A1
(43) Pub. Date: Dec. 19, 2019

(54) ENDFIRE LINEAR ARRAY MICROPHONE

(71) Applicant: Shure Acquisition Holdings, Inc., Niles, IL (US)

(72) Inventor: Jordan Schultz, Chicago, IL (US)

(21) Appl. No.: 16/418,712

(22) Filed: May 21, 2019

Related U.S. Application Data
(60) Provisional application No. 62/685,602, filed on Jun. 15, 2018.

(51) Int. Cl. H04R 3/00; H04R 3/04; H04R 1/40

(52) U.S. Cl. CPC H04R 3/005; H04R 1/406; H04R 3/04

(57) ABSTRACT

Endfire linear array microphone systems and methods with consistent directionality and performance at different frequency ranges are provided. The endfire linear array microphone includes a delay and sum beamformer and a differential beamformer. The delay and sum beamformer may produce pickup patterns with good directionality at higher frequency ranges, but cause the pickup patterns to become more omnidirectional at lower frequencies. The differential beamformer may produce pickup patterns with good directionality at lower frequencies. By combining the delay and sum beamformer and differential beamformer within the linear array microphone, the overall directionality of the linear array microphone may be maintained at different frequency ranges while using the same microphone elements.

### CROSS-REFERENCE TO RELATED APPLICATIONS

This application claims priority from U.S. Provisional Application Ser. No. 62/685,602, filed on Jun. 15, 2018, the content of which is incorporated herein by reference in its entirety.

### TECHNICAL FIELD

This application generally relates to an array microphone. In particular, this application relates to an endfire linear array microphone with consistent directionality and performance at different frequency ranges through the use of a delay and sum beamformer and a differential beamformer.

### BACKGROUND

Conferencing environments, such as conference rooms, boardrooms, video conferencing applications, and the like, can involve the use of microphones for capturing sound from various audio sources active in such environments. Such audio sources may include humans speaking, for example. The captured sound may be disseminated to a local audience in the environment through amplified speakers (for sound reinforcement), and/or to others remote from the environment (such as via a telecast and/or a webcast). The types of microphones and their placement in a particular environment may depend on the locations of the audio sources, physical space requirements, aesthetics, room layout, and/or other considerations. For example, in some environments, the microphones may be placed on a table or lectern near the audio sources. In other environments, the microphones may be mounted overhead to capture the sound from the entire room, for example. Accordingly, microphones are available in a variety of sizes, form factors, mounting options, and wiring options to suit the needs of particular environments.

Traditional microphones typically have fixed polar patterns and few manually selectable settings. To capture sound in a conferencing environment, many traditional microphones can be used at once to capture the audio sources within the environment. However, traditional microphones tend to capture unwanted audio as well, such as room noise, echoes, and other undesirable audio elements. The capturing of these unwanted noises is exacerbated by the use of many microphones.

Array microphones having multiple microphone elements can provide benefits such as steerable coverage or pick up patterns, which allow the microphones to focus on the desired audio sources and reject unwanted sounds such as room noise. The ability to steer audio pick up patterns provides the benefit of being able to be less precise in microphone placement, and in this way, array microphones are more forgiving. Moreover, array microphones provide the ability to pick up multiple audio sources with one array microphone or unit, again due to the ability to steer the pickup patterns.

However, array microphones may have certain shortcomings, including the fact that they are typically relatively larger than traditional microphones, and their fixed size often limits where they can be placed in an environment. In particular, the microphone elements in a linear array microphone may be situated relatively close together so that the linear array microphone can be placed in space-limited locations, such as podiums or desktops. The microphone elements in the linear array microphone may be paired together and be spaced certain distances apart. A delay and sum beamformer may be used to combine the signals from the microphone elements in order to achieve a certain pickup pattern. However, due to the relatively small distances between microphone elements, the performance of the linear array microphone at low frequencies may be limited. For example, the distance between a pair of microphone elements may be much smaller than a wavelength at a particular low frequency, which can cause the resulting pickup pattern of the linear array microphone at that low frequency to have less directionality and be more omnidirectional (instead of the desired pickup pattern). As such, at low frequencies, short linear array microphones may not consistently exhibit acceptable directionality.

Accordingly, there is an opportunity for an array microphone that addresses these concerns. More particularly, there is an opportunity for a linear array microphone that provides improved directionality and performance at different frequency ranges through the use of a delay and sum beamformer and a differential beamformer.

### SUMMARY

The invention is intended to solve the above-noted problems by providing array microphone systems and methods that are designed to, among other things: (1) provide a delay and sum beamformer for use with a first frequency range; (2) provide a differential beamformer for use with a second frequency range that is lower than the first frequency range; (3) output a beamformed output signal based on beamformed signals generated by the delay and sum beamformer and the differential beamformer; and (4) have a more consistent directionality and performance at different frequency ranges.

In an embodiment, an array microphone includes a plurality of microphones arranged in a plurality of groups, a delay and sum beamformer, a differential beamformer, and an output generation unit. Each of the plurality of microphones may be configured to detect sound and output an audio signal, and each group of the plurality of groups may include two of the plurality of microphones and may be configured to cover a different frequency range. The delay and sum beamformer may be in communication with the plurality of microphones, and be configured to generate a first beamformed signal based on the audio signals of the plurality of microphones when a frequency of the detected sound is within a first frequency range. The differential beamformer may be in communication with the plurality of microphones, and be configured to generate a second beamformed signal based on the audio signals of the plurality of microphones when the frequency of the detected sound is within a second frequency range lower than the first frequency range. The output generation unit may be in communication with the delay and sum beamformer and the differential beamformer, and be configured to generate a beamformed output signal based on the first and second beamformed signals. The beamformed output signal may correspond to a pickup pattern and include the first beamformed signal when a frequency of the detected sound is within a first frequency range and the second beamformed signal when the frequency of the detected sound is within a second frequency range.

In another embodiment, a method of beamforming audio signal of a plurality of microphones in an array microphone may include outputting an audio signal from each of the plurality of microphones based on detected sound; receiving the audio signals from the plurality of microphones at a delay and sum beamformer and a differential beamformer that are both in communication with the plurality of microphones; generating a first beamformed signal using the delay and sum beamformer when a frequency of the detected sound is within a first frequency range, based on the audio signals of the plurality of microphones; generating a second beamformed signal using the differential beamformer when the frequency of the detected sound is within a second frequency range lower than the first frequency range, based on the audio signals of the plurality of microphones; and generating a beamformed output signal with an output generation unit, based on the first and second beamformed signals. The beamformed output signal may correspond to a pickup pattern and include the first beamformed signal when a frequency of the detected sound is within a first frequency range and the second beamformed signal when the frequency of the detected sound is within a second frequency range. The plurality of microphones may be arranged in a plurality of groups. Each group of the plurality of groups may include two of the plurality of microphones and may be configured to cover a different frequency range.

In a further embodiment, an array microphone may include a plurality of microphones arranged in a plurality of groups and disposed along a common axis of the array microphone; a delay and sum beamformer; a differential beamformer; and an output generation unit. Each of the plurality of microphones may be configured to detect sound and output an audio signal, and each group of the plurality of groups may include two of the plurality of microphones and be configured to cover a different frequency range. The delay and sum beamformer may be in communication with the plurality of microphones and be configured to generate a first beamformed signal based on the audio signals of the plurality of microphones when a frequency of the detected sound is within a first frequency range. The differential beamformer may be communication with the plurality of microphones and be configured to generate a second beamformed signal based on the audio signals of the plurality of microphones when the frequency of the detected sound is within a second frequency range lower than the first frequency range. The output generation unit may be in communication with the delay and sum beamformer and the differential beamformer, and be configured to generate a beamformed output signal based on the first and second beamformed signals, where the beamformed output signal corresponds to a pickup pattern.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a linear array microphone, in accordance with some embodiments.

FIG. 2 is a graph showing the relative frequency response of nested groups of microphone elements in the linear array microphone of FIG. 1, in accordance with some embodiments.

FIG. 3 is a block diagram of the linear array microphone of FIG. 1, in accordance with some embodiments.

FIG. 4 is a block diagram of a delay and sum beamformer in the linear array microphone of FIG. 3, in accordance with some embodiments.

FIG. 5 is a block diagram of a differential beamformer in the linear array microphone of FIG. 3, in accordance with some embodiments.

FIG. 6 is a flowchart illustrating operations for beamforming of audio signals of a plurality of microphones in a linear array microphone, in accordance with some embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The linear array microphone systems and methods described herein can more consistently sense sounds in an environment and provide good directionality and performance at different frequency ranges. The linear array microphone may include a plurality of microphone elements, and a delay and sum beamformer and a differential beamformer that are each in communication with the microphone elements. The delay and sum beamformer and the differential beamformer may be optimized to produce pickup patterns with good directionality in different frequency ranges. In particular, the delay and sum beamformer may produce pickup patterns with good directionality at higher frequency ranges, but cause the pickup patterns to become more omnidirectional at lower frequencies. The differential beamformer, on the other hand, may produce pickup patterns with good directionality at lower frequencies. By combining the delay and sum beamformer and differential beamformer within the same linear array microphone, the overall directionality of the linear array microphone may be maintained at different frequency ranges while using the same microphone elements. In other words, the beamformed output signal of the linear array microphone may correspond to a pickup pattern that can be more consistently maintained at different frequency ranges.

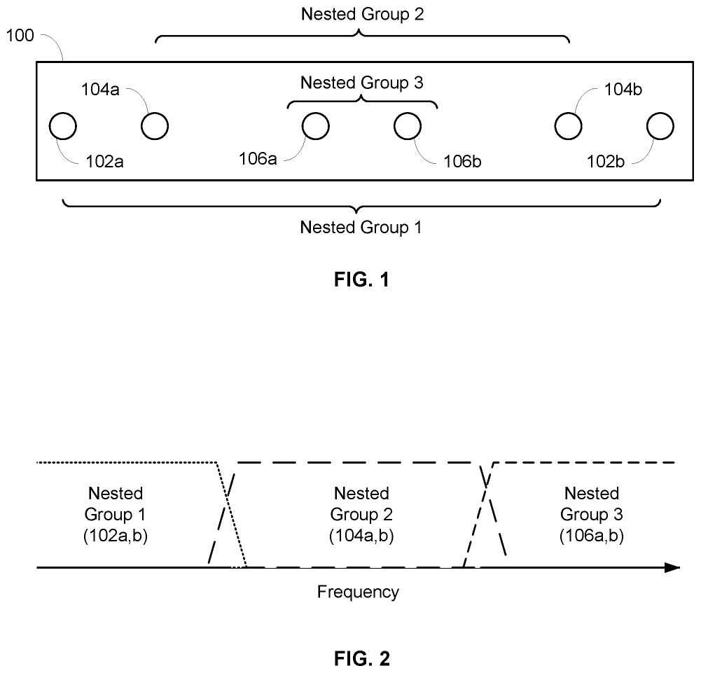

FIG. 1 is a schematic diagram of a linear array microphone 100 that can detect sounds from an audio source at various frequencies. The linear array microphone 100 may be utilized in a conference room or boardroom, for example, where the audio source may be one or more human speakers. Other sounds may be present in the environment which may be undesirable, such as noise from ventilation, other persons, audio/visual equipment, electronic devices, etc. In a typical situation, the audio sources may be seated in chairs at a table, although other configurations and placements of the audio sources are contemplated and possible.

The linear array microphone 100 may be placed on a table, lectern, desktop, etc. so that the sound from the audio sources can be detected and captured, such as speech spoken by human speakers. The linear array microphone 100 may include multiple microphone elements 102a,b, 104a,b, and 106a,b, and be able to form multiple pickup patterns so that the sound from the audio sources is more consistently detected and captured. In FIG. 1, the microphone elements 102a,b, 104a,b, and 106a,b may be generally arranged in a linear fashion along the length of the linear array microphone 100. In embodiments, the microphone elements 102a,b, 104a,b, and 106a,b may be disposed along a common axis of the linear array microphone 100. Although six microphone elements 102a,b, 104a,b, and 106a,b are depicted in FIG. 1, other numbers of microphone elements are possible and contemplated.

The polar patterns that can be formed by the linear array microphone 100 may be dependent on the type of beamformer used with the microphone elements 102a,b, 104a,b, and 106a,b. For example, a delay and sum beamformer may form a frequency-dependent polar pattern based on its filter structure and the layout geometry of the microphone elements 102a,b, 104a,b, and 106a,b. As another example, a differential beamformer may form a cardioid, subcardioid, supercardioid, hypercardioid, or bidirectional polar pattern.

The microphone elements 102a,b, 104a,b, and 106a,b in the linear array microphone 100 may each be a MEMS (micro-electrical mechanical system) microphone, in some embodiments. In other embodiments, the microphone elements 102a,b, 104a,b, and 106a,b may have other polar patterns and/or may be electret condenser microphones, dynamic microphones, ribbon microphones, piezoelectric microphones, and/or other types of microphones.

Each of the microphone elements 102a,b, 104a,b, and 106a,b in the linear array microphone 100 may detect sound and convert the sound to an analog audio signal. Components in the linear array microphone 100, such as analog to digital converters, processors, and/or other components, may process the analog audio signals and ultimately generate one or more digital audio output signals. The digital audio output signals may conform to the Dante standard for transmitting audio over Ethernet, in some embodiments, or may conform to another standard. One or more pickup patterns may be formed by the processor in the linear array microphone 100 from the audio signals of the microphone elements 102a,b, 104a,b, and 106a,b, and the processor may generate a digital audio output signal corresponding to each of the pickup patterns. In other embodiments, the microphone elements 102a,b, 104a,b, and 106a,b in the linear array microphone 100 may output analog audio signals so that other components and devices (e.g., processors, mixers, recorders, amplifiers, etc.) external to the linear array microphone 100 may process the analog audio signals.

As depicted in FIG. 1, the microphone elements 102a,b, 104a,b, and 106a,b in the linear array microphone 100 may be organized in nested groups. In particular, each nested group may include a pair of the microphone elements 102a,b, 104a,b, and 106a,b. In FIG. 1, a first nested group (“Nested Group 1”) may include microphone elements 102a,b that are located at the outer ends of the linear array microphone 100; a second nested group (“Nested Group 2”) may include microphone elements 104a,b that are located within the first nested group; and a third nested group (“Nested Group 3”) may include microphone elements 106a,b that are located within the second nested group. While three nested groups are shown in FIG. 1, other numbers of nested groups (and microphone elements) are possible and contemplated.

As depicted in the graph of FIG. 2, each nested group can be configured to cover a different frequency range when used with beamformer, such as a delay and sum beamformer. The relative frequency response of each nested group is shown in FIG. 2. In particular, Nested Group 1 (including microphone elements 102a,b) may be configured to cover a lower frequency range, Nested Group 2 (including microphone elements 104a,b) may be configured to cover a middle frequency range, and Nested Group 3 (including microphone elements 106a,b) may be configured to cover a higher frequency range.

If the microphone elements 102a,b, 104a,b, and 106a,b are only used with a delay and sum beamformer, then the performance of the linear array microphone 100 at lower frequencies may be limited. This limited performance may be due to the distance between microphone elements 102a,b being much smaller than a wavelength at a particular low frequency, and cause the pickup pattern of the linear array microphone 100 at that low frequency to undesirably become more omnidirectional. In particular, if the distance between a pair of microphone elements is less than a ¼ wavelength for a particular pickup frequency, the resultant polar pattern for a delay and sum beamformer may start to approach omnidirectional. For example, if the microphone elements 102a,b are spaced 20 mm apart, the directionality of the linear array microphone 100 can quickly deteriorate below 4300 Hz.

However, as described below, because the linear array microphone 100 utilizes both a delay and sum beamformer and a differential beamformer, the performance of the linear array microphone 100 at lower frequencies may be improved. In particular, the directionality and desired pickup pattern of the linear array microphone 100 may be maintained at different frequency ranges, including at lower frequencies.

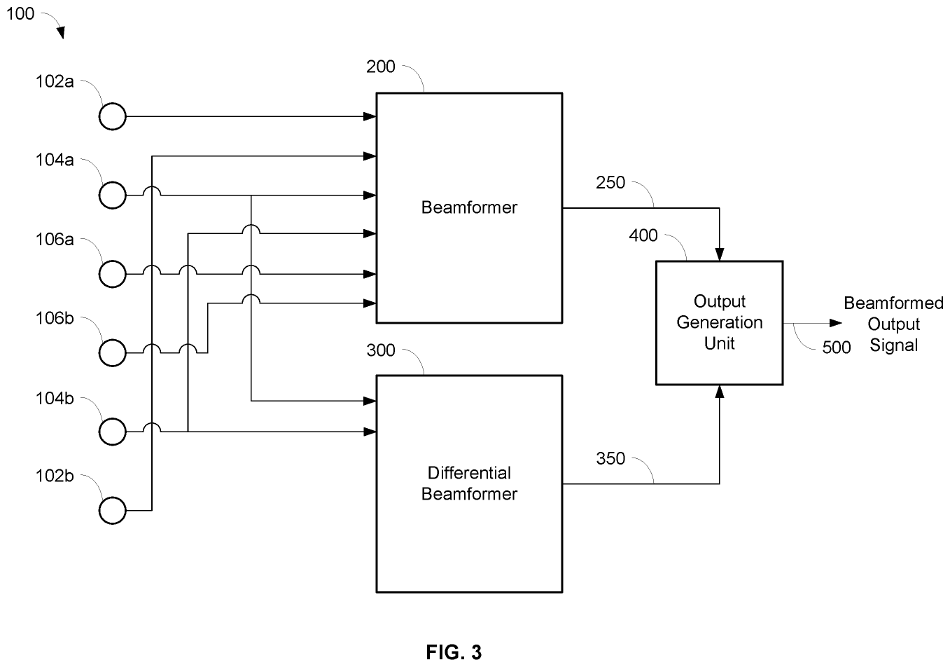

FIG. 3 is a block diagram of the linear array microphone 100. The linear array microphone 100 may include microphone elements 102a,b, 104a,b, and 106a,b; a delay and sum beamformer 200, a differential beamformer 300, and an output generation unit 400. Various components included in the linear array microphone 100 may be implemented using software executable by a computing device with a processor and memory, and/or by hardware (e.g., discrete logic circuits, application specific integrated circuits (ASIC), programmable gate arrays (PGA), field programmable gate arrays (FPGA), etc.

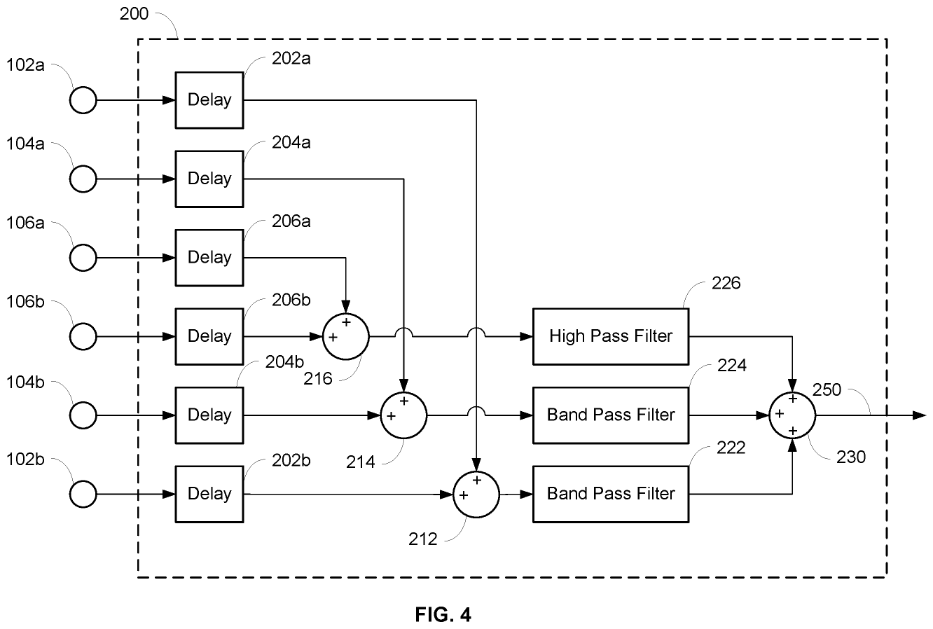

Both the delay and sum beamformer 200 and the differential beamformer 300 may be in communication with some or all of the microphone elements 102a,b, 104a,b, and 106a,b. In particular, the delay and sum beamformer 200 may be in communication with all of the microphone elements 102a,b, 104a,b, and 106a,b. The delay and sum beamformer 200 may be used to beamform audio at frequencies other than in a particular low frequency range. The delay and sum beamformer 200 is described in more detail below with respect to FIG. 4.

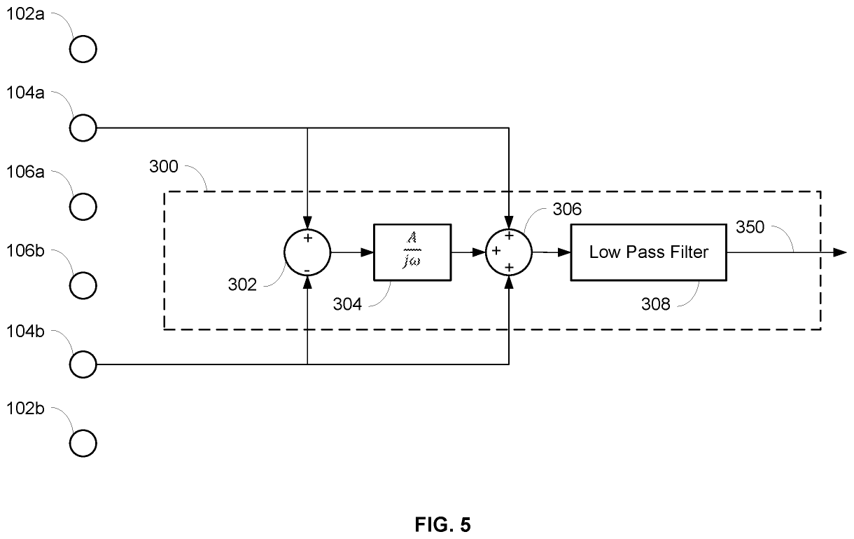

The differential beamformer 300 may be in communication with the microphone elements 104a,b (Nested Group 2). The differential beamformer 300 may be used to beamform audio in a particular low frequency range. In this particular embodiment and configuration of the linear array microphone 100 shown in FIG. 1, microphone elements 104a,b can be used with the differential beamformer 300 because the microphone elements in the other nested groups have larger distances between them. These larger distances are generally not usable with the differential beamformer 300 due to comb filtering at very low frequencies. In other embodiments, the geometry, arrangement, grouping, and pairings of the microphone elements may vary, which can result in different microphone elements being in communication with the differential beamformer 300. For example, in some embodiments, the outermost microphone elements of a linear array microphone may be close enough together to be useful with a differential beamformer. The differential beamformer 300 is described in more detail below with respect to FIG. 5.

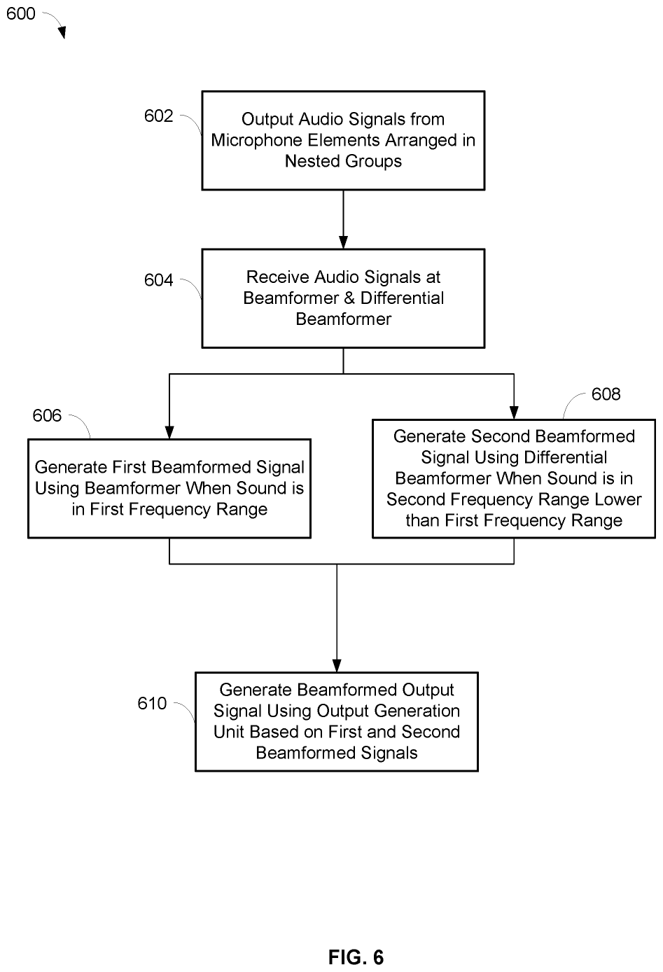

An embodiment of a process 600 for beamforming of audio signals in the linear array microphone 100 is shown in FIG. 6. The process 600 may be utilized to output a beamformed output signal from the linear array microphone 100 shown in FIG. 3 that maintains the directionality of a desired pickup pattern at different frequency ranges. One or more processors and/or other processing components (e.g., analog to digital converters, encryption chips, etc.) within or external to the microphone may perform any, some, or all of the steps of the process 600. One or more other types of components (e.g., memory, input and/or output devices, transmitters, receivers, buffers, drivers, discrete components, etc.) may also be utilized in conjunction with the processors and/or other processing components to perform any, some, or all of the steps of the process 600.

At step 602, audio signals may be output from the microphone elements 102a,b, 104a,b, and 106a,b. The microphone elements 102a,b, 104a,b, and 106a,b may be paired and arranged in groups, such as in the nested groups shown in FIG. 1. The audio signals from the microphone elements 102a,b, 104a,b, and 106a,b may be received at the delay and sum beamformer 200 and the differential beamformer 300 at step 604. In particular, the delay and sum beamformer 200 may receive the audio signals from all of the microphone elements 102a,b, 104a,b, and 106a,b, while the differential beamformer 300 may receive the audio signals from the microphone elements 104a,b, as described above.

At step 606, a first beamformed signal 250 may be generated by the delay and sum beamformer 200. The first beamformed signal 250 may be generated by the delay and sum beamformer 200 when the sound in the detected audio signals is in a first frequency range. This first frequency range may include middle and higher frequencies, and be above a particular low frequency where the delay and sum beamformer 200 has poorer performance due to the loss of directionality of the desired pickup pattern. In embodiments, the particular low frequency may be approximately 1 kHz.

At step 608, a second beamformed signal 350 may be generated by the differential beamformer 300. The second beamformed signal 350 may be generated by the differential beamformer 300 when the sound in the detected audio signals is in a second frequency range. This second frequency range may be lower than the first frequency range, and be at or below the particular low frequency described above. In embodiments, steps 606 and 608 may be performed substantially at the same time or may be performed at different times.

One or more beamformed output signals 500 may be generated by an output generation unit 400 at step 610. The beamformed output signal 500 may be based on the first and second beamformed signals 250, 350 that are generated by the delay and sum beamformer 200 and the differential beamformer 300, respectively. In particular, the beamformed output signal 500 may be the first beamformed signal 250 when a frequency of the sound in the detected audio signals is in the first frequency range, or may be the second beamformed signal 350 when the frequency of the sound in the detected audio signals is in the second frequency range.

In embodiments, the beamformed output signal 500 may be a mix of the first and second beamformed signals 250, 350 when the frequency of the sound in the detected audio signals is in an overlapping region of the first and second frequency ranges. For example, the filters in the delay and sum beamformer 200 and the differential beamformer 300 may pass frequencies that overlap. The overlap between such filters may be due to the shape and steepness of the filters used in the delay and sum beamformer 200 and the differential beamformer 300.

In embodiments, the beamformed output signal 500 may be an analog or a digital signal. If the beamformed output signal 500 is a digital signal, it may conform to the Dante standard for transmitting audio over Ethernet, for example. In embodiments, the beamformed output signal 500 may be output to components or devices (e.g., processors, mixers, recorders, amplifiers, etc.) external to the linear array microphone 100.

FIG. 4 shows a block diagram of the delay and sum beamformer 200 in the linear array microphone 100. The delay and sum beamformer 200 may be in communication with all of the microphone elements 102a,b, 104a,b, and 106a,b. Accordingly, the audio signals from the microphone elements 102a,b, 104a,b, and 106a,b may be processed by the delay and sum beamformer 200 to generate the first beamformed signal 250 when the sound in the audio signal is in a first frequency range. As described below, the first frequency range may include frequencies that are above a particular low frequency where the delay and sum beamformer 200 has poorer performance due to the loss of directionality of the desired pickup pattern.

The audio signals from each of the microphone elements 102a,b, 104a,b, and 106a,b may be delayed an appropriate amount by respective delay elements 202a,b, 204a,b, and 206a,b to achieve endfire directionality. The amount of delay for a particular delay element 202a,b, 204a,b, and 206a,b may be based on the location of the microphone elements 102a,b, 104a,b, and 106a,b on the linear array microphone 100, how the microphone elements all of the microphone elements 102a,b, 104a,b, and 106a,b are paired and grouped, and the speed of sound. In an example, the audio source may be on one end of the linear array microphone 100 near microphone element 102a, as shown in FIG. 1. Microphone element 102a may be paired with microphone element 102b in the same nested group.

However, in this example, sound from the audio source would arrive at a different time at microphone element 102a as compared to microphone element 102b. Thus, in order to time align the audio signal from microphone element 102a with the audio signal from microphone element 102b for appropriate beamforming, there may be a delay added by the delay element 202a to the audio signal from microphone element 102a. The delay may be the amount of time it takes the sound from the audio source to travel between microphone element 102a and microphone element 102b.

After a delay is applied by the delay elements 202a,b, 204a,b, and 206a,b, the delayed audio signals may be respectively added at summing elements 212, 214, and 216. The summed signal from the summing element 212 may correspond to the microphone elements 102a,b (Nested Group 1) and be filtered by a band pass filter 222. Because microphone elements 102a,b are configured to cover a lower frequency range, the band pass filter 222 may be configured to pass frequencies from a particular low frequency, e.g., 1 kHz, to a middle frequency. As described above, the particular low frequency may be the frequency where the delay and sum beamformer 200 has poorer performance due to the loss of directionality of the desired pickup pattern.

Similarly, the summed signal from the summing element 214 may correspond to the microphone elements 104a,b (Nested Group 2) and be filtered by a band pass filter 224. The band pass filter 224 may be configured to pass frequencies in a middle frequency range that is higher than the frequency range passed by the band pass filter 222 but lower than the frequency passed by a band pass filter 226 (as described below).

Finally, the summed signal from the summing element 216 may correspond to microphone elements 106a,b (Nested Group 3) and be filtered by a high pass filter 226. The high pass filter 226 may be configured to pass frequencies in a higher frequency range that is higher than the frequency range passed by the band pass filter 224. The filtered summed signals from the filters 222, 224, and 226 may be summed by a summing element 230. The summing element 230 may generate the first beamformed signal 250. Accordingly, due to the frequency ranges passed by the filters 222, 224, and 226, the first beamformed signal 250 generated by the delay and sum beamformer 200 may be based on sounds from the audio source that are at a particular low frequency and above.

Sounds from the audio source that are below the particular low frequency can be processed by the differential beamformer 300 that is shown in FIG. 5. FIG. 5 shows a block diagram of the differential beamformer 300 in the linear array microphone 100. The differential beamformer 300 may be in communication with the microphone elements 104a,b. Accordingly, the audio signals from the microphone elements 104a,b may be processed by the differential beamformer 300 to generate the second beamformed signal 350 when the sound in the audio signal is in a second frequency range that is lower than the first frequency range (described above).

In contrast to the delay and sum beamformer 200 described above, the differential beamformer 300 does not delay the audio signals from the microphone elements, but instead takes a difference between the audio signals from the microphone elements. Accordingly, the audio signal from the microphone element 104b may be subtracted from the audio signal from the microphone element 104a by a summing element 302. Because the difference between audio signals is taken, the linear array microphone 100 is most sensitive to sounds coming from audio sources at 90 degrees, i.e., at one end of the linear array microphone 100.

The resulting signal from the summing element 302 may be passed through a transfer function 304. The signal from the transfer function 304 may be added to the respective audio signals from the microphone elements 104a,b by a summing element 306. The resulting signal from the summing element 306 may be filtered by a low pass filter 308 to generate the second beamformed signal 350. In embodiments, the low pass filter 308 may be a first order low pass Butterworth filter. The low pass filter 308 may be configured to pass frequencies lower than the particular low frequency, e.g., 1 kHz (where the delay and sum beamformer 200 has poorer performance due to the loss of directionality of the desired pickup pattern). Accordingly, due to the low frequency range passed by the filter 308, the second beamformed signal 350 generated by the differential beamformer 300 may be based on sounds from the audio source that are at a particular low frequency and below.

Subsequently, as described above, the first and second beamformed signals 250, 350 may be processed by an output generation unit 400 to generate a beamformed output signal 500. The beamformed output signal 500 from the linear microphone array 100 can therefore correspond to a pickup pattern that has its directionality more consistently maintained at various frequency ranges.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. An array microphone, comprising:
a plurality of microphones arranged in a plurality of groups, wherein:
each of the plurality of microphones is configured to detect sound and output an audio signal; and
each group of the plurality of groups comprises two of the plurality of microphones and is configured to cover a different frequency range;
a delay and sum beamformer in communication with the plurality of microphones, the delay and sum beamformer configured to generate a first beamformed signal based on the audio signals of the plurality of microphones when a frequency of the detected sound is within a first frequency range;
a differential beamformer in communication with the plurality of microphones, the differential beamformer configured to generate a second beamformed signal based on the audio signals of the plurality of microphones when the frequency of the detected sound is within a second frequency range lower than the first frequency range; and
an output generation unit in communication with the delay and sum beamformer and the differential beamformer, and configured to generate a beamformed output signal based on the first and second beamformed signals, wherein the beamformed output signal corresponds to a pickup pattern and comprises:
the first beamformed signal when a frequency of the detected sound is within a first frequency range;
the second beamformed signal when the frequency of the detected sound is within a second frequency range.

2. The array microphone of claim 1, wherein the plurality of microphones is disposed along a common axis of the array microphone.

3. The array microphone of claim 1, wherein at least one group of the plurality of groups is nested within another group of the plurality of groups.

4. The array microphone of claim 1, wherein each of the plurality of microphones comprises an omnidirectional microphone.

5. The array microphone of claim 1, wherein the beamformed output signal further comprises a mix of the first and second beamformed signals when the frequency of the detected sound is within an overlapping region of the first and second frequency ranges.

6. The array microphone of claim 1, wherein the delay and sum beamformer comprises a plurality of filters each configured to pass a different frequency subrange of the first frequency range.

7. A method of beamforming audio signals of a plurality of microphones in an array microphone, comprising:
outputting an audio signal from each of the plurality of microphones based on detected sound, wherein the plurality of microphones is arranged in a plurality of groups, wherein each group of the plurality of groups comprises two of the plurality of microphones and is configured to cover a different frequency range;
receiving the audio signals from the plurality of microphones at a delay and sum beamformer and a differential beamformer that are both in communication with the plurality of microphones;
generating a first beamformed signal using the delay and sum beamformer when a frequency of the detected sound is within a first frequency range, based on the audio signals of the plurality of microphones;
generating a second beamformed signal using the differential beamformer when the frequency of the detected sound is within a second frequency range lower than the first frequency range, based on the audio signals of the plurality of microphones;
generating a beamformed output signal with an output generation unit, based on the first and second beamformed signals, wherein the beamformed output signal corresponds to a pickup pattern and comprises:
the first beamformed signal when a frequency of the detected sound is within a first frequency range; and
the second beamformed signal when the frequency of the detected sound is within a second frequency range.

8. The method of claim 7, wherein the plurality of microphones is disposed along a common axis of the array microphone.

9. The method of claim 7, wherein at least one group of the plurality of groups is nested within another group of the plurality of groups.

10. The method of claim 7, wherein each of the plurality of microphones comprises an omnidirectional microphone.

11. The method of claim 7, wherein the beamformed output signal further comprises a mix of the first and second beamformed signals when the frequency of the detected sound is within an overlapping region of the first and second frequency ranges.

12. The method of claim 7, wherein generating the first beamformed signals comprises passing a different frequency subrange of the first frequency range.

13. An array microphone, comprising:
a plurality of microphones arranged in a plurality of groups and disposed along a common axis of the array microphone, wherein:
each of the plurality of microphones is configured to detect sound and output an audio signal; and
each group of the plurality of groups comprises two of the plurality of microphones and is configured to cover a different frequency range;
a delay and sum beamformer in communication with the plurality of microphones, the delay and sum beamformer configured to generate a first beamformed signal based on the audio signals of the plurality of microphones when a frequency of the detected sound is within a first frequency range;
a differential beamformer in communication with the plurality of microphones, the differential beamformer configured to generate a second beamformed signal based on the audio signals of the plurality of microphones when the frequency of the detected sound is within a second frequency range lower than the first frequency range; and
an output generation unit in communication with the delay and sum beamformer and the differential beamformer, and configured to generate a beamformed output signal based on the first and second beamformed signals, wherein the beamformed output signal corresponds to a pickup pattern.

14. The array microphone of claim 13, wherein at least one group of the plurality of groups is nested within another group of the plurality of groups.

15. The array microphone of claim 13, wherein the beamformed output signal comprises:
the first beamformed signal when a frequency of the detected sound is within a first frequency range; and
the second beamformed signal when the frequency of the detected sound is within a second frequency range.

16. The array microphone of claim 15, wherein the beamformed output signal further comprises a mix of the first and second beamformed signals when the frequency of the detected sound is within an overlapping region of the first and second frequency ranges.

17. The array microphone of claim 13, wherein each of the plurality of microphones comprises an omnidirectional microphone.

18. The array microphone of claim 13, wherein the delay and sum beamformer comprises a plurality of filters each configured to pass a different frequency subrange of the first frequency range.
